(19) United States
(12) Patent Application Publication
(10) Pub. No.: US 2026/0067030 A1
(43) Pub. Date: Mar. 5, 2026

(54) TECHNIQUES FOR RATE MATCHING ADAPTATION FOR POLAR-CODED PHYSICAL BROADCAST CHANNEL

(71) Applicant: Lenovo (United States) Inc., Morrisville, NC (US)

(72) Inventors: Abir Ben Hadj Fredj, Frankfurt am main (DE); Razvan-Andrei Stoica, Witten (DE); Karthikeyan Ganesan, Nauheim (DE); Ali Ramadan Ali, Kraiburg am Inn (DE)

(21) Appl. No.: 19/381,930

(22) Filed: Nov. 6, 2025

(51) Int. Cl. H04L 1/00

(52) U.S. Cl. CPC H04L 1/0067; H04L 1/0057

(57) ABSTRACT

Various aspects of the present disclosure relate to techniques for rate matching adaptation for polar-coded physical broadcast channel (PBCH). A network equipment is configured to encode a PBCH payload to generate a polar codeword according to a polar reliability sequence, select, based on a synchronization signal block (SSB) bandwidth, a rate matching pattern from a plurality of predefined rate matching patterns, perform bit-level rate matching on the polar codeword in accordance with the selected rate matching pattern, and map quadrature phase-shift keying (QPSK) symbols corresponding to the rate-matched polar codeword to resource elements of an SSB resource grid for transmission.

### TECHNICAL FIELD

The present disclosure relates to wireless communications, and more specifically to techniques for rate matching adaptation for polar-coded physical broadcast channel (PBCH).

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE) and methods of the present disclosure each have several innovative aspects, no single one of which is solely responsible for the desirable features disclosed herein.

An NE for wireless communication is described. The NE may be configured to, capable of, or operable to encode a PBCH payload to generate a polar codeword according to a polar reliability sequence, select, based on a synchronization signal block (SSB) bandwidth, a rate matching pattern from a plurality of predefined rate matching patterns, perform bit-level rate matching on the polar codeword in accordance with the selected rate matching pattern, and map quadrature phase-shift keying (QPSK) symbols corresponding to the rate-matched polar codeword to resource elements of an SSB resource grid for transmission.

A processor for wireless communication is described. The processor may be configured to, capable of, or operable to encode a PBCH payload to generate a polar codeword according to a polar reliability sequence, select, based on an SSB bandwidth, a rate matching pattern from a plurality of predefined rate matching patterns, perform bit-level rate matching on the polar codeword in accordance with the selected rate matching pattern, and map QPSK symbols corresponding to the rate-matched polar codeword to resource elements of an SSB resource grid for transmission.

A method for wireless communication performed by a NE is described. The method may be configured to, capable of, or operable to encode a PBCH payload to generate a polar codeword according to a polar reliability sequence, select, based on an SSB bandwidth, a rate matching pattern from a plurality of predefined rate matching patterns, perform bit-level rate matching on the polar codeword in accordance with the selected rate matching pattern, and map QPSK symbols corresponding to the rate-matched polar codeword to resource elements of an SSB resource grid for transmission.

A UE for wireless communication is described. The UE may be configured to, capable of, or operable to receive a PBCH transmitted within an SSB resource grid, obtain, based on at least one of a carrier raster or a synchronization raster, a rate matching pattern corresponding to the PBCH, perform de-rate matching of a received polar codeword in accordance with the rate matching pattern, wherein reliabilities of punctured bits corresponding to noisy bit-channels are set to a predefined minimum value, decode the PBCH using a cyclic redundancy check (CRC)-aided successive-cancellation-list (SCL) decoder according to a polar reliability sequence defining reliable and noisy bit-channels, and recover a PBCH payload including a MIB from the polar codeword.

A processor for wireless communication is described. The processor may be configured to, capable of, or operable to receive a PBCH transmitted within an SSB resource grid, obtain, based on at least one of a carrier raster or a synchronization raster, a rate matching pattern corresponding to the PBCH, perform de-rate matching of a received polar codeword in accordance with the rate matching pattern, wherein reliabilities of punctured bits corresponding to noisy bit-channels are set to a predefined minimum value, decode the PBCH using a CRC-aided SCL decoder according to a polar reliability sequence defining reliable and noisy bit-channels, and recover a PBCH payload including a MIB from the polar codeword.

A method for wireless communication performed by a UE is described. The method may be configured to, capable of, or operable to receive a PBCH transmitted within an SSB resource grid, obtain, based on at least one of a carrier raster or a synchronization raster, a rate matching pattern corresponding to the PBCH, perform de-rate matching of a received polar codeword in accordance with the rate matching pattern, wherein reliabilities of punctured bits corresponding to noisy bit-channels are set to a predefined minimum value, decode the PBCH using a CRC-aided SCL decoder according to a polar reliability sequence defining reliable and noisy bit-channels, and recover a PBCH payload including a MIB from the polar codeword.

### BRIEF DESCRIPTION OF THE DRAWINGS

FIG. 1 illustrates an example of a wireless communications system in accordance with aspects of the present disclosure.

FIG. 2 depicts one example of a time-frequency structure of an SSB in accordance with aspects of the present disclosure.

FIG. 3 illustrates an example polar code transmitting chain to generate and transmit a PBCH according to aspects of the present disclosure.

FIG. 4 illustrates an example representation of channel polarization 400 in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by an NE in accordance with aspects of the present disclosure.

FIG. 9 illustrates a flowchart of a method performed by a UE in accordance with aspects of the present disclosure.

### DETAILED DESCRIPTION

Modern wireless communication systems rely on channel coding to achieve reliable transmission of data over noisy wireless environments. Channel coding schemes, commonly referred to as forward error correction (FEC) codes, introduce redundancy into transmitted information so that the receiver can accurately reconstruct the original message even when some bits are corrupted by channel noise or interference. A theoretical upper limit—known as the channel capacity—is defined as the maximum achievable transmission rate for reliable communication under given noise conditions.

In the 5G New Radio (NR) standard, different FEC schemes are adopted for various physical channel types: low-density parity-check (LDPC) codes are employed for data channels, while PC/CRC-aided polar codes are used for control and broadcast channels. In particular, the PBCH—which carries the Master Information Block (MIB) and enables UE to synchronize and access the network—is encoded using polar codes. The PBCH is transmitted as part of the SSB, which also includes the Primary Synchronization Signal (PSS) and Secondary Synchronization Signal (SSS). For legacy enhanced mobile broadband (eMBB) devices, the SSB typically occupies a 5 MHz carrier bandwidth, corresponding to 20 resource blocks (RBs) in the frequency domain.

However, newer categories of reduced capability (RedCap) devices—introduced in later 3GPP releases to support cost-and power-efficient IoT and industrial applications—often operate with reduced SSB bandwidths, for example 3 MHz (12 RBs). When the SSB bandwidth is reduced, the PBCH resource elements at the top and bottom of the SSB resource grid are punctured (i.e., omitted from transmission). Conventional systems perform this RB-level puncturing without regard to the internal structure of the polar code. As a result, the puncturing may remove code bits that belong to reliable bit-channels rather than frozen bit-channels, degrading the effectiveness of the polar decoder and significantly increasing the block error rate (BLER). Simulation results show that such RB-level puncturing can cause up to a 7-10 dB coverage loss for reduced-bandwidth configurations.

To address these issues, the present disclosure introduces mechanisms for polar-sequence-aware rate matching and puncturing that preserve the integrity of the PBCH under varying bandwidth and device configurations. In a first aspect, a bit-level rate matching procedure is provided in which puncturing, shortening, or repetition is performed at the bit level in accordance with the polar reliability sequence rather than across entire resource blocks. The term “bit-level rate matching” refers to the process of adjusting the length of a polar-encoded codeword by performing one or more of puncturing, shortening, or repetition at the bit level, in accordance with a polar reliability sequence. The term “polar reliability sequence” refers to an ordering of synthesized bit-channel indices representing their relative reliability in a polar code, used to identify information bit-channels and frozen bit-channels. This ensures that frozen bits—which correspond to inherently noisy or unreliable bit-channels and are known to both the transmitter and receiver—are preferentially removed during puncturing, while information and parity bits occupying reliable channels are preserved. The term “frozen bit” refers to a bit in a polar code that corresponds to an unreliable bit-channel and is typically assigned a fixed, known value (e.g., zero) at both transmitter and receiver. By dynamically adapting the rate matching pattern based on SSB bandwidth and device type (e.g., 3 MHz RedCap vs. 5 MHz eMBB), the proposed bit-level puncturing scheme achieves improved link robustness and up to 5-6 dB gain in BLER performance relative to conventional RB-level methods.

In a second aspect, a channel interleaver design is introduced to improve performance when RB-level puncturing cannot be avoided. The term “channel interleaver” refers to a functional block that reorders encoded bits before modulation and mapping to resource elements (REs) such that certain bit positions (e.g., frozen bits) align with REs likely to be punctured under reduced bandwidth conditions. The interleaver reorders the bits of the polar codeword such that bits corresponding to frozen channels are mapped to resource elements likely to be punctured (e.g., at the upper and lower frequency edges of the SSB), while bits corresponding to reliable channels are mapped to central resource elements. This interleaving scheme minimizes the negative impact of RB-level truncation on decoding performance without altering the existing rate matching or polar encoding process. At the receiver side, a corresponding de-interleaver restores the original bit order before decoding.

Together, these mechanisms provide flexible and backward-compatible improvements to PBCH transmission in 5G NR systems, enabling robust coverage across diverse device categories and carrier bandwidths while maintaining compliance with standardized polar code constructions.

Aspects of the present disclosure are described in the context of a wireless communications system. Note that one or more aspects from different solutions may be combined.

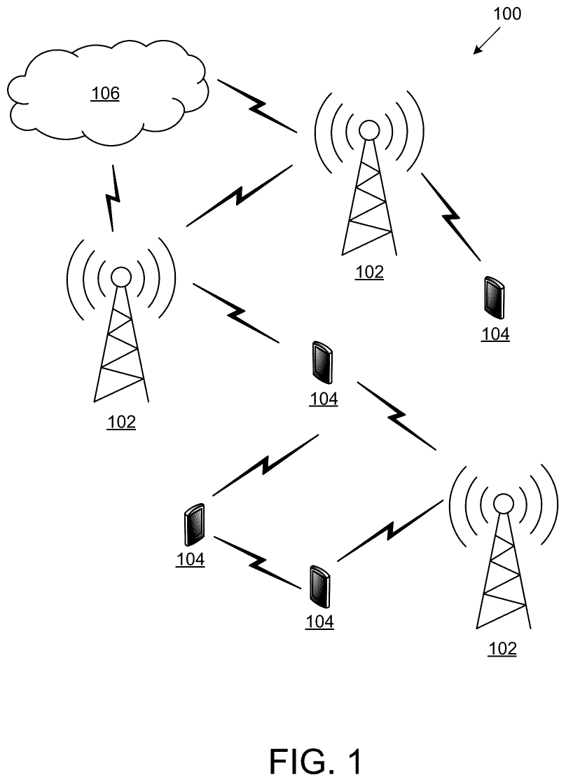

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as a Long-Term Evolution (LTE) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106). In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or a PDN connection, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

Within the wireless communications system 100 of FIG. 1, the solutions described herein may be implemented at the NE 102 and supported by one or more UE 104 operating within the coverage area of the NE 102 and connected to a CN 106. The NE 102, which may be or include a gNB, is configured to transmit a PBCH as part of an SSB to enable initial access and cell identification by the UE 104. Conventional PBCH transmission in legacy 5G NR networks employs resource-block-level (RB-level) puncturing when operating with reduced carrier bandwidths (for example, 3 MHz RedCap configurations), resulting in the removal of entire groups of resource elements without regard to the underlying polar code construction. Such RB-level puncturing disrupts the intended mapping of information bits and frozen bits defined by the polar reliability sequence, thereby degrading the reliability of decoded broadcast information and producing measurable BLER and coverage loss—often 7 dB to 10 dB for reduced minimum spectrum allocation devices.

To mitigate these deficiencies, the solutions disclosed herein enable the NE 102 to perform polar-sequence-aware rate matching (e.g., puncturing). In particular, the NE 102 encodes the PBCH payload using a polar encoder to generate a polar codeword and then applies bit-level rate matching according to a selected rate-matching pattern that is adaptive to the SSB bandwidth. The puncturing process is applied in accordance with the polar reliability sequence so that frozen bits corresponding to noisy or unreliable bit-channels are selectively removed/not transmitted while information and parity bits (e.g., CRC bits) transmitted over reliable channels are preserved. In some examples, a channel interleaver within the NE 102 may reorder the polar codeword bits such that frozen bits are mapped to REs at the upper and lower edges of the SSB resource grid—regions most likely to be punctured—while reliable bits are mapped toward the center of the grid. The UE 104, upon receiving the PBCH, performs corresponding de-rate-matching and de-interleaving operations based on the same rate-matching pattern, allowing standard CRC-aided SCL decoding without modification to the existing 5G NR receiver chain. By incorporating bit-level rate matching and intelligent interleaving into the transmission procedures of NE 102, the disclosed system achieves improved PBCH robustness, expanded coverage for reduced-bandwidth devices, and backward compatibility with legacy UE 104 implementations.

In a wireless communication system, a UE 104 performs cell search procedures to acquire time and frequency synchronization and to detect the physical layer cell identity (PCI) of a serving cell. During cell search, which may occur when the UE 104 is powered on, performing reselection, or entering from another radio access technology, the UE 104 uses synchronization signals and the PBCH to obtain system information necessary to access the cell.

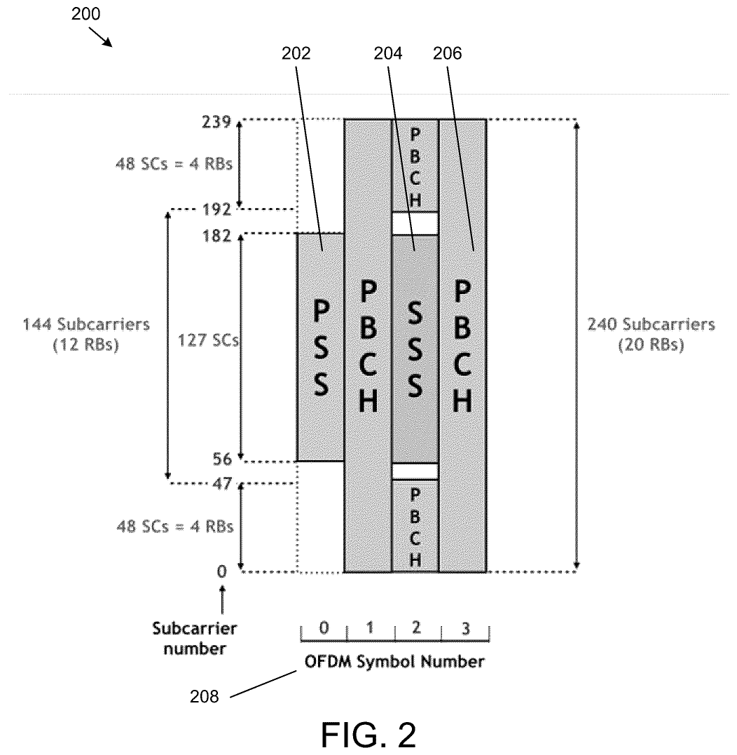

FIG. 2 depicts one example of a time-frequency structure of an SSB in accordance with aspects of the present disclosure. In 5G NR systems, the synchronization signal and PBCH block (SSB) 200 includes a primary synchronization signal (PSS) 202, a secondary synchronization signal (SSS) 204, and the PBCH 206. Each SSB 200 spans four orthogonal frequency division multiplexing (OFDM) symbols 208 in time and occupies 240 subcarriers (20 resource blocks) in frequency. The PSS 202 and SSS 204 facilitate time and frequency synchronization and cell identification, while the PBCH 206 carries the master information block (MIB), which provides configuration information to enable initial network access.

Within the SSB, the PBCH 206 occupies two full OFDM symbols 208 and parts of a third, corresponding to 576 total resource elements, of which a subset is reserved for PBCH demodulation reference signals (DM-RS). The remaining elements carry the PBCH payload. The SSB 200 may be periodically transmitted with a configurable periodicity (e.g., 5 ms to 160 ms) and may be transmitted in multiple beams within an SSB burst set to support beam sweeping. The number of candidate SSBs and their periodicity are determined according to parameters such as carrier frequency and bandwidth.

For PBCH transmission, 5G NR employs polar codes as the FEC scheme. Polar codes achieve channel capacity for symmetric binary-input discrete memoryless channels. The principle of channel polarization divides bit-channels into reliable and unreliable (noisy) subsets. Reliable bit-channels carry information bits, while unreliable channels carry frozen bits, typically set to zero and known to both transmitter and receiver. In NR, the PBCH payload of 32 bits is encoded using a CRC-aided polar code to produce a 512-bit codeword, which is then rate-matched to fit the number of available resource elements.

Polar codes are attractive for PBCH because of their structured construction and efficient decoding using SCL algorithms, which approach maximum-likelihood performance for moderate list sizes. However, the reliability of each bit-channel is sensitive to how the codeword is mapped and punctured when adapting to different bandwidths or device capabilities. In particular, when resource-block-level (RB-level) puncturing is used to accommodate reduced-bandwidth configurations, such as 3 MHz SSB bandwidth for RedCap devices, the puncturing may inadvertently remove bits associated with reliable bit-channels, degrading BLER performance and cell coverage.

The solutions described herein address this issue by introducing bit-level rate matching and polar-sequence-aware puncturing techniques, as well as interleaving methods, that preserve the reliability structure of the polar code during PBCH transmission for both legacy and reduced-bandwidth devices.

In one example, a transmitter or NE 102, such as a gNB, may employ different PBCH rate-matching patterns depending on the carrier bandwidths and device types supported within a wireless communications system 100. In particular, the NE 102 may adapt PBCH transmission for enhanced Mobile Broadband (eMBB) UEs 104 operating with a legacy 5 MHz SSB bandwidth, and for RedCap UEs 104 operating with a reduced 3 MHz SSB bandwidth.

In one example, the NE 102 may encode a PBCH payload—such as a MIB—using a polar encoder configured in accordance with, e.g., the polar reliability sequence defined in 3GPP TS 38.212 (incorporated herein by reference). The resulting polar codeword may then be processed by a sub-block interleaver and a rate-matching module prior to modulation, for example, QPSK. The rate-matching process may include one or more of puncturing, shortening, or repetition operations, selected according to a mother-code length (A), a desired output-sequence length (E), and an effective code rate R_eff=K/E, where K is the number of information bits. The NE 102 may determine the output-sequence length (E) based on the number of available REs within the SSB resource grid and select an appropriate rate-matching pattern from a plurality of predefined patterns (e.g., R₁ for 5 MHz eMBB and R₂ for 3 MHz RedCap).

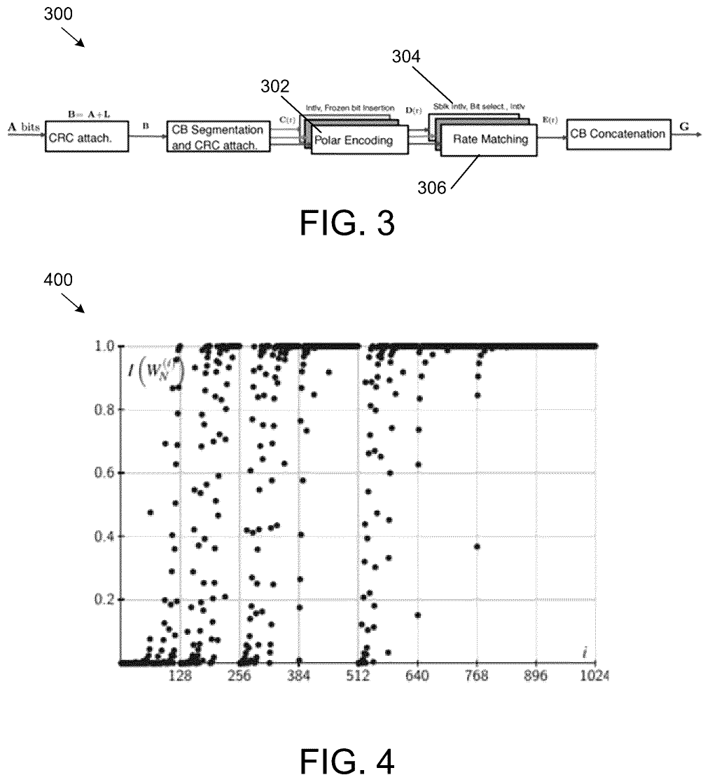

In some examples, bit-level rate matching may be performed instead of the resource-block-level (RB-level) puncturing used in conventional systems. Under bit-level operation, puncturing is applied in accordance with the polar reliability sequence such that bits corresponding to frozen bit-channels—representing degraded or noisy synthesized channels—are preferentially removed, while bits corresponding to information or parity bit-channels are preserved. Because frozen bits are known to both the transmitter and receiver and are typically set to 0, their removal does not disturb decoding reliability. As illustrated conceptually in FIG. 3, the polar encoding and rate-matching chain may thereby maintain the intended bit-channel polarization behavior, depicted in FIG. 4, where reliable channels approach capacity and unreliable channels approach zero capacity.

FIG. 3 illustrates an example polar code transmitting chain 300 that may be implemented at the NE 102 to generate and transmit a PBCH according to aspects of the present disclosure. In this example, the transmitting chain 300 includes a series of functional blocks that process a PBCH payload—such as a MIB—for transmission within an SSB. The transmitting chain 300 may include a polar encoder 302, a sub-block interleaver 304, and a rate-matching module 306. The transmitting chain may also include a modulator and an RE mapper. In some examples, one or more of these modules may be implemented by processing circuitry of the NE 102 or as functional components of a baseband processor.

During operation, the polar encoder 302 encodes the PBCH payload in accordance with a polar reliability sequence, generating a polar codeword of fixed mother-code length. The sub-block interleaver 304 may permute the encoded bits to improve frequency and time diversity prior to rate matching. The rate-matching module 306 then adapts the polar codeword to the number of available REs within the SSB resource grid by performing one or more of bit-level puncturing, shortening, or repetition. In some implementations, puncturing is applied according to the polar reliability sequence such that bits corresponding to frozen or unreliable bit-channels are removed before bits corresponding to reliable information channels. The rate-matched codeword may then be modulated by the modulator, for example, using QPSK, to produce complex modulation symbols. The RE mapper assigns the resulting symbols to specific REs within the SSB grid for transmission over the air interface.

In certain implementations, the transmitting chain 300 may also include an optional channel interleaver that is configured to reorder bits of the polar codeword prior to RE mapping. The interleaver may be activated when the SSB bandwidth is reduced below a predefined threshold (e.g., 3 MHz) to ensure that frozen bits are mapped to REs likely to be punctured, while information bits remain mapped to central REs. Together, the modules of FIG. 3 enable bandwidth-adaptive, polar-sequence-aware rate matching that preserves code reliability and improves PBCH decoding performance across different device types and carrier configurations.

FIG. 4 illustrates an example representation of channel polarization 400 in accordance with aspects of the present disclosure. Channel polarization refers to the process by which a group of synthesized bit-channels separate into distinct categories of reliable and unreliable (or noisy) channels as the codeword length increases. The illustrated distribution in FIG. 4 depicts the bit-channel reliability index across the set of encoded bits, demonstrating how some bit-channels approach near-perfect reliability while others become effectively unusable for data transmission.

In one example, the most reliable bit-channels—indicated toward the right side of FIG. 4—are designated as information bit-channels used to carry data or parity bits. The least reliable bit-channels—indicated toward the left side of FIG. 4—are designated as frozen bit-channels, which are typically assigned fixed, known values (for example, zero) at both the NE 102 and UE 104. The boundary between reliable and frozen bit-channels may be determined by a predetermined universal polar reliability sequence as defined, for example, in 3GPP TS 38.212 or by other construction algorithms such as density evolution or Gaussian approximation.

The polarization process underlies the solutions described herein. By aligning bit-level rate matching (e.g., puncturing) with the reliability ordering of these bit-channels, the NE 102 ensures that only frozen bits (i.e., those transmitted over inherently noisy channels) are removed when bandwidth reductions require puncturing. This targeted puncturing preserves the reliability of the information-bearing channels, thereby improving the BLER and overall link robustness of PBCH transmissions, particularly for reduced-bandwidth configurations such as 3 MHz RedCap deployments. Accordingly, FIG. 4 conceptually demonstrates the polarization principle leveraged by the bit-level rate-matching and interleaving schemes described herein.

In one configuration, the UE 104 may implicitly determine which rate-matching pattern was used at the NE 102 based on an SSB bandwidth indicator. To decode a received PBCH codeword, the UE 104 may employ a CRC-aided SCL decoder that assigns zero or minimal reliability values to punctured bits corresponding to frozen channels. Because the puncturing pattern is consistent with the polar sequence design, the UE 104 can accurately reconstruct the transmitted payload without significant degradation in BLER performance.

By contrast, if puncturing was applied without regard to the polar sequence—as in existing RB-level approaches—the punctured positions could correspond to reliable information channels or parity bits, severely impacting decoder performance. Simulation studies indicate that such conventional RB-level puncturing, when reducing the SSB bandwidth from 5 MHz to 3 MHz while maintaining the same PBCH symbol allocation, can lead to a 7-10 dB coverage loss. In comparison, the disclosed bit-level rate-matching techniques yield an observed gain of approximately 5-6 dB in BLER performance by preserving bit-channel reliability and maintaining the structural integrity of the polar code during bandwidth adaptation.

Accordingly, the first example provides a transmitter-side mechanism within the NE 102 that adaptively selects rate-matching patterns and performs polar-sequence-aware bit-level puncturing. This mechanism enables efficient PBCH transmission across different carrier bandwidths while ensuring backward compatibility with standard UE 104 decoding operations, thereby enhancing coverage and link robustness for both eMBB and RedCap devices.

In another example, a channel interleaver may be incorporated into the PBCH encoding chain of the NE 102 to further enhance broadcast performance under reduced bandwidth conditions. Similar to interleaving schemes used for uplink control information (UCI), the channel interleaver may be selectively activated when the SSB bandwidth is smaller than a predetermined threshold, such as when operating below the legacy 5 MHz configuration (for example, a 3 MHz RedCap deployment). When activated, the interleaver may reorder bits within the polar codeword so that frozen bits—corresponding to unreliable or noisy bit-channels—are mapped to REs most likely to be punctured, while information bits or parity bits are mapped to REs more centrally located within the SSB resource grid. This arrangement ensures that subsequent resource-block-level (RB-level) puncturing primarily removes frozen bits rather than reliable information bits, preserving decoder performance even when full-rate bit-level adaptation is not employed.

In one example, the channel interleaver may be configured using the polar reliability sequence, including the set of frozen bits (S_F) and the set of information bits (S_I), to guide bit reordering prior to mapping. In another example, the interleaver may select from two or more predefined interleaving patterns based on parameters such as the number of available RBs, the SSB bandwidth, or an SSB carrier raster configuration. For example, when operating over a reduced 3 MHz carrier, the interleaver may reorder bits so that frozen-bit positions are mapped to REs at the top and bottom of the SSB grid (e.g., the four RBs or forty-eight subcarriers at each edge), while reliable information-bit positions are mapped toward the center of the SSB. As a result, any RB-level puncturing applied to the outer RBs will primarily affect frozen bits, minimizing BLER degradation.

At the receiver side, the UE 104 may employ a channel de-interleaver to restore the original bit order prior to polar decoding. The UE 104 may perform standard CRC-aided SCL decoding using the same rate-matching parameters as in the legacy configuration, with no change to decoder logic. The channel de-interleaver may be preconfigured at the UE 104. In some examples, the de-interleaver may be informed of which interleaving pattern was used by the transmitter, ensuring that bits are correctly reordered before decoding. Because the underlying polar reliability sequence and rate-matching structure remain unchanged, the UE 104 can decode PBCH transmissions from both legacy and reduced-bandwidth cells without modification to existing receiver architecture.

This interleaver-based approach provides an alternative and complementary technique to the bit-level puncturing of the first example. By intelligently reordering polar codeword bits prior to RB-level puncturing, the disclosed solution achieves comparable improvements in BLER performance and coverage without requiring new rate-matching logic or bandwidth-specific polar code reconstructions. Accordingly, the second example enables a polar-sequence-aware interleaving and mapping process that maintains link robustness and backward compatibility across a range of SSB bandwidth configurations.

In another example, aspects of the present disclosure relate to the operation of a UE 104 configured to receive and decode a PBCH transmitted according to one or more of the techniques described above. The UE 104 may be configured to operate in various bandwidth modes, for example, a 5 MHz eMBB configuration or a 3 MHz RedCap configuration. Depending on the SSB bandwidth, the UE 104 may determine or obtain a corresponding rate-matching pattern used by the transmitting NE 102.

In one example, the UE 104 may implicitly determine the applicable rate-matching pattern based on knowledge of the SSB carrier raster, synchronization raster, or other bandwidth-defining parameters. For example, a UE configured to detect a 3 MHz SSB bandwidth may automatically infer that a rate-matching pattern R₂ was applied at the transmitter, while a 5 MHz configuration may correspond to pattern R₁.

Upon receiving the PBCH, the UE 104 may perform de-rate matching of the received polar codeword according to the determined rate-matching pattern. During this operation, the UE 104 may assign reliability metrics to each bit position of the codeword. In particular, the reliabilities of bits corresponding to punctured positions may be set to a predefined minimum value, for example, a log-likelihood ratio (LLR) of zero or an equivalent null reliability value. This ensures that punctured bits are treated as completely unreliable during decoding, consistent with their status as frozen bits or noisy bit-channels in the polar reliability sequence. The remaining, non-punctured bits—corresponding to reliable information or parity bit-channels—may retain their channel-derived reliability values.

The UE 104 may then perform polar decoding using a CRC-aided SCL decoder, which traverses the decoding tree in accordance with the polar reliability sequence used at the NE 102. Because the puncturing and rate-matching procedures at the transmitter are aligned with the polar sequence design, the UE 104 may successfully decode the PBCH even under reduced-bandwidth conditions. In some examples, the same decoder configuration and list size may be applied for both eMBB and RedCap modes, ensuring backward compatibility and minimizing complexity in the UE receiver.

If a channel interleaver was used at the NE 102, the UE 104 may employ a corresponding channel de-interleaver prior to decoding. The de-interleaver may reorder bits of the received polar codeword to restore the original bit order used in the encoding process. The NE 102 or another configuration entity may provide the UE 104 with information identifying which interleaving pattern was applied, through predefined mapping rules. Once de-interleaving and de-rate matching are complete, the UE 104 may proceed with CRC-aided decoding to recover the PBCH payload, such as the MIB.

Through the disclosed receiver-side operations, the UE 104 is able to reliably decode PBCH transmissions generated under variable bandwidth conditions without any change to the core decoding algorithm. When paired with the transmitter-side methods described above, the overall system maintains consistent decoding performance across both full-bandwidth and reduced-bandwidth SSB configurations. Simulation studies indicate that, when the UE 104 applies the described reliability assignment and de-rate matching procedures, the PBCH decoding gain achieved with bit-level puncturing or interleaving-based RB-level puncturing may exceed 5 dB relative to conventional RB-level puncturing techniques.

The solutions described herein provide several benefits over conventional PBCH transmission and decoding techniques used in 5G NR networks. By introducing polar-sequence-aware rate matching and optional channel interleaving, the disclosed approaches significantly improve PBCH reliability and cell-coverage performance for both eMBB and RedCap devices operating with different SSB bandwidths.

In one aspect, the use of bit-level rate matching aligned with the polar reliability sequence enables the NE 102 to puncture frozen bits—corresponding to unreliable or noisy bit-channels—while preserving information and parity bits carried on reliable channels. This design maintains the integrity of the polar code structure and prevents performance degradation that typically occurs with RB-level puncturing. Simulation analyses indicate a 5-6 dB improvement in BLER performance and a corresponding extension of cell coverage compared to existing NR implementations that apply RB-level puncturing without regard to bit-channel reliability.

In another aspect, the optional channel interleaver allows the NE 102 to reorder polar-encoded bits so that frozen bits are mapped to REs most likely to be punctured (e.g., at the edges of the SSB resource grid), while reliable bits are mapped toward the center. This interleaving strategy enables improved BLER performance and link robustness even when RB-level puncturing must be used due to system bandwidth constraints. Because the interleaving and de-interleaving operations may be performed using existing physical-layer structures, the approach requires minimal modifications to current 5G NR transmitter and receiver designs.

At the receiver side, the UE 104 may perform de-rate matching, de-interleaving (if applicable), and CRC-aided SCL decoding using standard algorithms. The UE 104 may infer configuration information identifying the applied rate-matching or interleaving pattern, allowing accurate decoding without increasing processing complexity or latency. The described mechanisms are fully backward compatible with legacy decoding procedures and do not require any change to the 3GPP-defined polar code construction.

Collectively, these enhancements provide a flexible, implementation-efficient framework for PBCH transmission across diverse device capabilities and carrier bandwidths. The disclosed techniques improve system coverage, reduce BLER, and maintain compliance with standardized encoding and decoding chains, making them well suited for next-generation wireless communication systems.

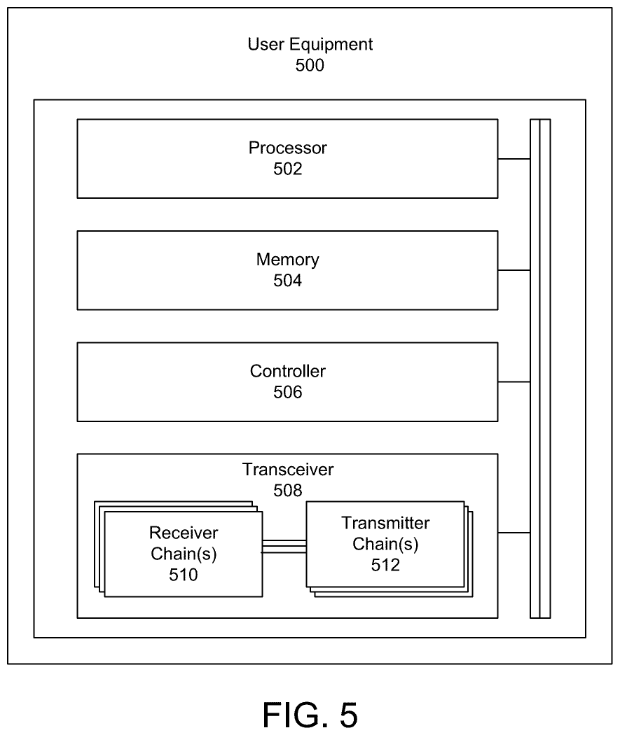

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a central processing unit (CPU), an ASIC, a field programmable gate array (FPGA), or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions that, when executed by the processor 502, cause the UE 500 to perform various functions described herein. The code may be stored in a non-transitory computer-readable medium such the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the UE functions described herein (e.g., executing, by the processor 502, instructions stored in the memory 504). Accordingly, the processor 502 may support wireless communication at the UE 500 in accordance with examples as disclosed herein.

In one example, a UE 500 is configured to receive a PBCH transmitted within an SSB resource grid, obtain, based on at least one of a carrier raster or a synchronization raster, a rate matching pattern corresponding to the PBCH, perform de-rate matching of a received polar codeword in accordance with the rate matching pattern, wherein reliabilities of punctured bits corresponding to noisy bit-channels are set to a predefined minimum value, decode the PBCH using a CRC-aided SCL decoder according to a polar reliability sequence defining reliable and noisy bit-channels, and recover a PBCH payload including a MIB from the polar codeword.

In one example, the UE 500 is configured to determine the rate matching pattern implicitly based on an SSB carrier raster, synchronization raster, or a combination thereof. In one example, the UE 500 is configured to de-rate match the polar codeword by inserting null or very small reliabilities for bits identified as punctured according to the rate matching pattern.

The controller 506 may manage input and output signals for the UE 500. The controller 506 may also manage peripherals not integrated into the UE 500. In some implementations, the controller 506 may utilize an operating system (OS) such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas for receiving the signal over the air or wireless medium. The receiver chain 510 may include at least one amplifier (e.g., a low-noise amplifier (LNA)) configured to amplify the received signal. The receiver chain 510 may include at least one demodulator configured to demodulate the received signal and obtain the transmitted data by reversing the modulation technique applied during transmission of the signal. The receiver chain 510 may include at least one decoder for decoding/ processing the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

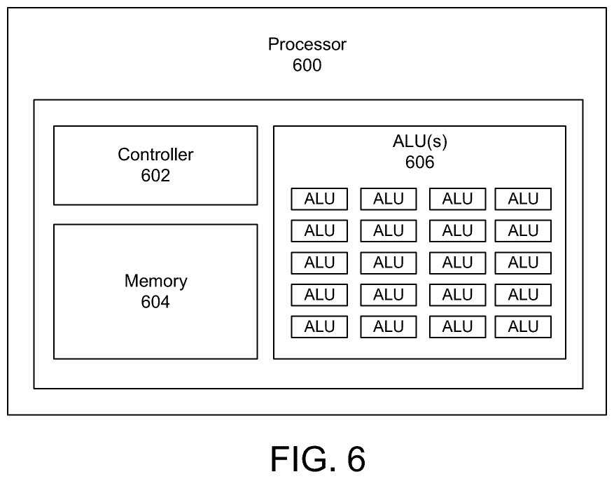

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory address of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, arithmetic logic units (ALUs), and other functional units of the processor 600.

The memory 604 may include one or more caches (e.g., memory local to or included in the processor 600 or other memory, such RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, the controller 602, and the memory 604 may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

In various examples, the processor 600 may support wireless communication of a UE, in accordance with examples as disclosed herein. In other examples, the processor 600 may support wireless communication of a RAN entity, in accordance with examples as disclosed herein.

In one example, the processor 600 is configured to encode a PBCH payload to generate a polar codeword according to a polar reliability sequence, select, based on an SSB bandwidth, a rate matching pattern from a plurality of predefined rate matching patterns, perform bit-level rate matching on the polar codeword in accordance with the selected rate matching pattern, and map QPSK symbols corresponding to the rate-matched polar codeword to resource elements of an SSB resource grid for transmission.

In one example, the processor 600 is configured to select the rate matching pattern based on a carrier bandwidth associated with an SSB. In one example, the processor 600 is configured to select the rate matching pattern based on a minimum SSB spectrum, determined according to at least one of an SSB carrier raster, a synchronization raster, or a combination thereof, and wherein the rate matching pattern is further selected to enable a UE to transmit or receive a PBCH within a 3 MHz or 5 MHz carrier bandwidth.

In one example, puncturing is applied according to the polar reliability sequence such that bits corresponding to noisy bit-channels are punctured. In one example, puncturing is applied in accordance with the polar reliability sequence such that bits corresponding to noisy or unreliable bit-channels of the polar reliability sequence are removed prior to bits corresponding to reliable bit-channels. In one example, the processor 600 is configured to activate a channel interleaver in response to the SSB bandwidth being less than a predefined threshold bandwidth.

In one example, the channel interleaver is configured to reorder bits of the polar codeword such that bits corresponding to noisy bit-channels are mapped to resource elements that are to be punctured, and bits corresponding to reliable bit-channels are mapped to resource elements that are not punctured. In one example, the channel interleaver is configured according to at least one of a polar sequence defining noisy and reliable bit sets or a predefined interleaving pattern selected based on an available number of resource blocks.

In one example, resource elements that are to be punctured are located at top and bottom portions of the SSB resource grid, and resource elements that are not punctured are located in a central portion of the SSB resource grid. In one example, the processor 600 includes a de-interleaver configured to provide interleaving pattern information to a UE for PBCH decoding.

In one example, the processor 600 is configured to determine an output sequence length and an effective code rate based on a number of resource elements available for SSB transmission, and to select the rate matching pattern based on the output sequence length and the effective code rate. In one example, the processor 600 is configured to generate a plurality of rate matching patterns respectively associated with different SSB bandwidths and to store the plurality of rate matching patterns in the at least one memory.

In one example, the plurality of rate matching patterns consider respective polar code constructions optimized for different code lengths. In one example, the processor 600 is configured to map the rate-matched polar codeword to QPSK symbols prior to resource-element mapping. In one example, the rate matching comprises at least one of puncturing, repetition, or shortening of the polar codeword according to the selected rate matching pattern.

In one example, the processor 600 is configured to receive a PBCH transmitted within an SSB resource grid, obtain, based on at least one of a carrier raster or synchronization raster, a rate matching pattern corresponding to the PBCH, perform de-rate matching of a received polar codeword in accordance with the rate matching pattern, wherein reliabilities of punctured bits corresponding to noisy bit-channels are set to a predefined minimum value, decode the PBCH using a CRC-aided SCL decoder according to a polar reliability sequence defining reliable and noisy bit-channels, and recover a PBCH payload including a MIB from the polar codeword.

In one example, the processor 600 is configured to determine the rate matching pattern implicitly based on an SSB carrier raster, synchronization raster, or a combination thereof. In one example, the processor 600 is configured to de-rate match the polar codeword by inserting null or very small reliabilities for bits identified as punctured according to the rate matching pattern.

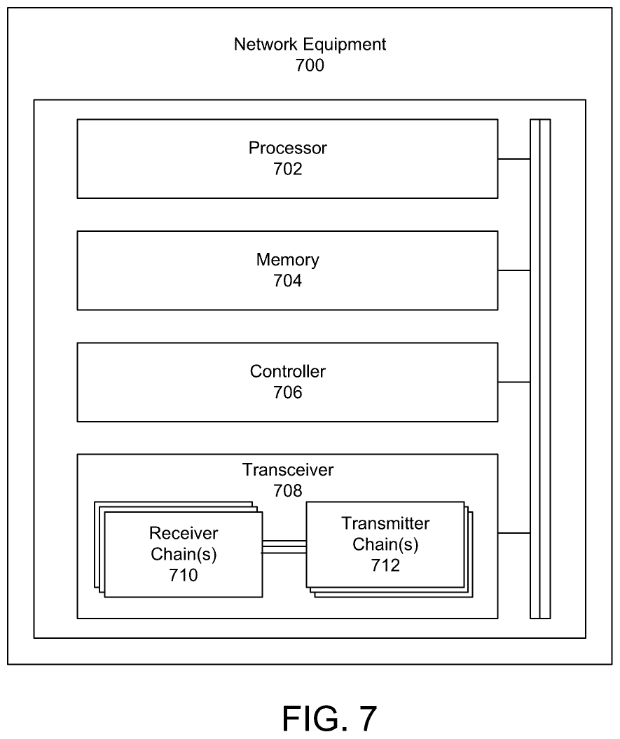

FIG. 7 illustrates an example of a NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the RAN functions described herein (e.g., executing, by the processor 702, instructions stored in the memory 704). For example, the processor 702 may support wireless communication at the NE 700 in accordance with examples as disclosed herein.

In one example, the NE 700 is configured to encode a PBCH payload to generate a polar codeword according to a polar reliability sequence, select, based on an SSB bandwidth, a rate matching pattern from a plurality of predefined rate matching patterns, perform bit-level rate matching on the polar codeword in accordance with the selected rate matching pattern, and map QPSK symbols corresponding to the rate-matched polar codeword to resource elements of an SSB resource grid for transmission.

In one example, the NE 700 is configured to select the rate matching pattern based on a carrier bandwidth associated with an SSB. In one example, the NE 700 is configured to select the rate matching pattern based on a minimum SSB spectrum, determined according to at least one of an SSB carrier raster, a synchronization raster, or a combination thereof, and wherein the rate matching pattern is further selected to enable a UE to transmit or receive a PBCH within a 3 MHz or 5 MHz carrier bandwidth.

In one example, puncturing is applied according to the polar reliability sequence such that bits corresponding to noisy bit-channels are punctured. In one example, puncturing is applied in accordance with the polar reliability sequence such that bits corresponding to noisy or unreliable bit-channels of the polar reliability sequence are removed prior to bits corresponding to reliable bit-channels. In one example, the NE 700 is configured to activate a channel interleaver in response to the SSB bandwidth being less than a predefined threshold bandwidth.

In one example, the channel interleaver is configured to reorder bits of the polar codeword such that bits corresponding to noisy bit-channels are mapped to resource elements that are to be punctured, and bits corresponding to reliable bit-channels are mapped to resource elements that are not punctured. In one example, the channel interleaver is configured according to at least one of a polar sequence defining noisy and reliable bit sets or a predefined interleaving pattern selected based on an available number of resource blocks.

In one example, resource elements that are to be punctured are located at top and bottom portions of the SSB resource grid, and resource elements that are not punctured are located in a central portion of the SSB resource grid. In one example, the NE 700 includes a de-interleaver configured to provide interleaving pattern information to a UE for PBCH decoding.

In one example, the NE 700 is configured to determine an output sequence length and an effective code rate based on a number of resource elements available for SSB transmission, and to select the rate matching pattern based on the output sequence length and the effective code rate. In one example, the NE 700 is configured to generate a plurality of rate matching patterns respectively associated with different SSB bandwidths and to store the plurality of rate matching patterns in the at least one memory.

In one example, the plurality of rate matching patterns consider respective polar code constructions optimized for different code lengths. In one example, the NE 700 is configured to map the rate-matched polar codeword to QPSK symbols prior to resource-element mapping. In one example, the rate matching comprises at least one of puncturing, repetition, or shortening of the polar codeword according to the selected rate matching pattern.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas for receiving the signal over the air or wireless medium. The receiver chain 710 may include at least one amplifier (e.g., a low-noise amplifier (LNA)) configured to amplify the received signal. The receiver chain 710 may include at least one demodulator configured to demodulate the received signal and obtain the transmitted data by reversing the modulation technique applied during transmission of the signal. The receiver chain 710 may include at least one decoder for /coding/ processing the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

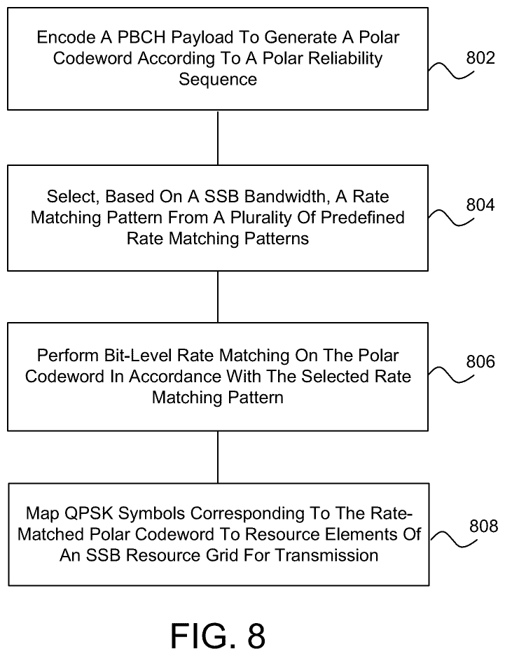

FIG. 8 illustrates a flowchart of a method performed by an NE 700 in accordance with aspects of the present disclosure. The operations of the method may be implemented by an NE 700 as described herein. In some implementations, the NE 700 may execute a set of instructions to control the function elements of the NE 700 to perform the described functions.

At step 802, the method may encode a PBCH payload to generate a polar codeword according to a polar reliability sequence. The operations of step 802 may be performed in accordance with examples as described herein. In some implementations, aspects of the operations of step 802 may be performed by an NE 700, as described with reference to FIG. 7.

At step 804, the method may select, based on an SSB bandwidth, a rate matching pattern from a plurality of predefined rate matching patterns. The operations of step 804 may be performed in accordance with examples as described herein. In some implementations, aspects of the operations of step 804 may be performed by an NE 700, as described with reference to FIG. 7.

At step 806, the method may perform bit-level rate matching on the polar codeword in accordance with the selected rate matching pattern. The operations of step 806 may be performed in accordance with examples as described herein. In some implementations, aspects of the operations of step 806 may be performed by an NE 700, as described with reference to FIG. 7.

At step 808, the method may map QPSK symbols corresponding to the rate-matched polar codeword to resource elements of an SSB resource grid for transmission. The operations of step 808 may be performed in accordance with examples as described herein. In some implementations, aspects of the operations of step 808 may be performed by an NE 700, as described with reference to FIG. 7.

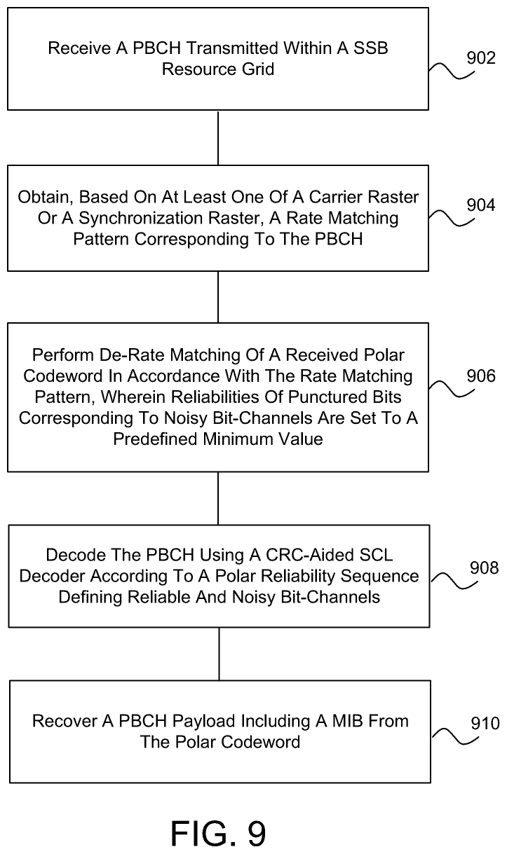

FIG. 9 illustrates a flowchart of a method performed by a UE 500 in accordance with aspects of the present disclosure. The operations of the method may be implemented by a UE 500 as described herein. In some implementations, the UE 500 may execute a set of instructions to control the function elements of the UE 500 to perform the described functions.

At step 902, the method may receive a PBCH transmitted within an SSB resource grid. The operations of step 902 may be performed in accordance with examples as described herein. In some implementations, aspects of the operations of step 902 may be performed by a UE 500, as described with reference to FIG. 5.

At step 904, the method may obtain, based on at least one of a carrier raster or a synchronization raster, a rate matching pattern corresponding to the PBCH. The operations of step 904 may be performed in accordance with examples as described herein. In some implementations, aspects of the operations of step 904 may be performed by a UE 500, as described with reference to FIG. 5.

At step 906, the method may perform de-rate matching of a received polar codeword in accordance with the rate matching pattern, wherein reliabilities of punctured bits corresponding to noisy bit-channels are set to a predefined minimum value. The operations of step 906 may be performed in accordance with examples as described herein. In some implementations, aspects of the operations of step 906 may be performed by a UE 500, as described with reference to FIG. 5.

At step 908, the method may decode the PBCH using a CRC-aided SCL decoder according to a polar reliability sequence defining reliable and noisy bit-channels. The operations of step 908 may be performed in accordance with examples as described herein. In some implementations, aspects of the operations of step 908 may be performed by a UE 500, as described with reference to FIG. 5.

At step 910, the method may recover a PBCH payload including a MIB from the polar codeword. The operations of step 910 may be performed in accordance with examples as described herein. In some implementations, aspects of the operations of step 910 may be performed by a UE 500, as described with reference to FIG. 5.

It should be noted that the method described herein describes one possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network equipment (NE) for wireless communication, comprising:
at least one memory; and
at least one processor coupled with the at least one memory and configured to cause the NE to:
encode a physical broadcast channel (PBCH) payload to generate a polar codeword according to a polar reliability sequence;
select, based on a synchronization signal block (SSB) bandwidth, a rate matching pattern from a plurality of predefined rate matching patterns;
perform bit-level rate matching on the polar codeword in accordance with the selected rate matching pattern; and
map quadrature phase shift keying (QPSK) symbols corresponding to the rate-matched polar codeword to resource elements of an SSB resource grid for transmission.

2. The NE of claim 1, wherein the at least one processor is configured to cause the NE to select the rate matching pattern based on a carrier bandwidth associated with an SSB.

3. The NE of claim 1, wherein the at least one processor is configured to cause the NE to select the rate matching pattern based on a minimum SSB spectrum, determined according to at least one of an SSB carrier raster, a synchronization raster, or a combination thereof, and wherein the rate matching pattern is further selected to enable a user equipment (UE) to transmit or receive a PBCH within a 3 MHz or 5 MHz carrier bandwidth.

4. The NE of claim 1, wherein puncturing is applied according to the polar reliability sequence such that bits corresponding to noisy bit-channels are punctured.

5. The NE of claim 1, wherein puncturing is applied in accordance with the polar reliability sequence such that bits corresponding to noisy or unreliable bit-channels of the polar reliability sequence are removed prior to bits corresponding to reliable bit-channels.

6. The NE of claim 1, wherein the at least one processor is configured to cause the NE to activate a channel interleaver in response to the SSB bandwidth being less than a predefined threshold bandwidth.

7. The NE of claim 6, wherein the channel interleaver is configured to reorder bits of the polar codeword such that bits corresponding to noisy bit-channels are mapped to resource elements that are to be punctured, and bits corresponding to reliable bit-channels are mapped to resource elements that are not punctured.

8. The NE of claim 7, wherein the channel interleaver is configured according to at least one of a polar sequence defining noisy and reliable bit sets or a predefined interleaving pattern selected based on an available number of resource blocks.

9. The NE of claim 7, wherein resource elements that are to be punctured are located at top and bottom portions of the SSB resource grid, and resource elements that are not punctured are located in a central portion of the SSB resource grid.

10. The NE of claim 7, further comprising a de-interleaver configured to provide interleaving pattern information to a user equipment (UE) for PBCH decoding.

11. The NE of claim 1, wherein the at least one processor is configured to cause the NE to determine an output sequence length and an effective code rate based on a number of resource elements available for SSB transmission, and to select the rate matching pattern based on the output sequence length and the effective code rate.

12. The NE of claim 1, wherein the at least one processor is configured to cause the NE to generate a plurality of rate matching patterns respectively associated with different SSB bandwidths and to store the plurality of rate matching patterns in the at least one memory.

13. The NE of claim 12, wherein the plurality of rate matching patterns consider respective polar code constructions optimized for different code lengths.

14. The NE of claim 1, wherein the at least one processor is configured to cause the NE to map the rate-matched polar codeword to QPSK symbols prior to resource-element mapping.

15. The NE of claim 1, wherein rate matching comprises at least one of puncturing, repetition, or shortening of the polar codeword according to the selected rate matching pattern.

16. A method of a network equipment (NE), comprising:
encoding a physical broadcast channel (PBCH) payload to generate a polar codeword according to a polar reliability sequence;
selecting, based on a synchronization signal block (SSB) bandwidth, a rate matching pattern from a plurality of predefined rate matching patterns;
performing bit-level rate matching on the polar codeword in accordance with the selected rate matching pattern; and
mapping quadrature phase shift keying (QPSK) symbols corresponding to the rate-matched polar codeword to resource elements of an SSB resource grid for transmission.

17. A user equipment (UE) for wireless communication, comprising:
at least one memory; and
at least one processor coupled with the at least one memory and configured to cause the UE to:
receive a physical broadcast channel (PBCH) transmitted within a synchronization signal block (SSB) resource grid;
obtain, based on at least one of a carrier raster or a synchronization raster, a rate matching pattern corresponding to the PBCH;
perform de-rate matching of a received polar codeword in accordance with the rate matching pattern, wherein reliabilities of punctured bits corresponding to noisy bit-channels are set to a predefined minimum value;
decode the PBCH using a cyclic redundancy check (CRC)-aided successive cancellation list (SCL) decoder according to a polar reliability sequence defining reliable and noisy bit-channels; and
recover a PBCH payload including a master information block (MIB) from the polar codeword.

18. The UE of claim 17, wherein the at least one processor is configured to cause the UE to de-rate match the polar codeword by inserting null reliabilities for bits identified as punctured according to the rate matching pattern.

19. A method of a user equipment (UE), comprising:
receiving a physical broadcast channel (PBCH) transmitted within a synchronization signal block (SSB) resource grid;
obtaining, based on at least one of a carrier raster or a synchronization raster, a rate matching pattern corresponding to the PBCH;
performing de-rate matching of a received polar codeword in accordance with the rate matching pattern, wherein reliabilities of punctured bits corresponding to noisy bit-channels are set to a predefined minimum value;
decoding the PBCH using a cyclic redundancy check (CRC)-aided successive cancellation list (SCL) decoder according to a polar reliability sequence defining reliable and noisy bit-channels; and
recovering a PBCH payload including a master information block (MIB) from the polar codeword.

20. The method of claim 19, further comprising de-rate matching the polar codeword by inserting null reliabilities for bits identified as punctured according to the rate matching pattern.
